(19) United States
(12) Patent Application Publication
(10) Pub. No.: US 2010/0120958 A1
(43) Pub. Date: May 13, 2010

(54) Heat stabilized polyamide moulding composition

(75) Inventors: Huaili Qin, (US); Nanjian Sun, Shanghai (CN); Robert J. Palmer, Jonzier-Epagny (FR)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E. I. DU PONT DE NEMOURS AND COMPANY, Wilmington, DE (US)

(21) Appl. No.: 12/614,657

(22) Filed: Nov. 9, 2009

(30) Foreign Application Priority Data
Nov. 7, 2008 (CN) 200810175785.0

(51) Int. Cl. C08K 5/053; C08K 3/34; C09C 1/42

(52) U.S. Cl. 524/386; 524/443; 524/445; 524/447

(57) ABSTRACT

A polymer composition having improved heat stability is provided. The transition metal ion-modified clay can greatly increase the heat stability of the polymer especially the polyamide, with low cost.

### CROSS REFERENCE TO RELATED APPLICATIONS

This application claims the benefit of Chinese Application No. 200810175785.0, filed Nov. 7, 2008, which is incorporated herein by reference in its entirety.

### FIELD OF THE INVENTION

The present invention relates to a heat stabilizer used for polymer and a composition containing the heat stabilizer, specifically, a heat stabilizer containing modified clay and a polymer containing the heat stabilizer.

### BACKGROUND OF THE INVENTION

The heat stability of polymers used for various purposes is a very critical characteristic. When the plastic parts (such as in automobile, electrical or electronic equipment) are exposured under high temperature for a long period of time, their mechanical properties will decrease due to the thermal degradation of the polymers. This kind of phenomenon is also called heat aging. In order to prevent such decrease of mechanical properties, various heat stabilizers are usually added to polymers to improve their heat aging properties.

Polyamide is usually stabilized with heat stabilizers (e.g., phenolic antioxidant, aromatic amine and copper, either in the form of elementary copper, or in a form of copper salt in combination with potassium iodide or potassium bromide). Phenolic antioxidants or aromatic amine are usually used for stabilization at temperatures up to 130° C. Copper (I) iodide in combination with potassium iodide or potassium bromide are suitable for stabilization at higher temperatures. However, when the temperature is over 170° C., the heat stability is insufficient. Moreover, copper (I) iodide and potassium halides are very expensive, and the existence of halides would cause some corrosion problems. The rapid development of automobile industry and electronic industry requires better heat stability of polymer materials, temperature for long-term use of polyamide need to be elevated to 210° C., even higher at 230° C. According to reports, the elementary iron or ferrous oxide can effectively improve long-term heat aging properties of polyamides. However, the extrusion process of the iron powder would cause serious safety issues and dispersal problems, and the mechanical properties of polyamide materials would decline.

Therefore, there is an urgent need for a polyamide composition which holds very good high temperature heat stability.

### SUMMARY OF THE INVENTION

This invention aims to provide a new kind of polyamide composition which holds very good heat stability even at higher temperature.

This invention provides a polymer composition with improved heat stability, comprising transition metal ion-modified clay and a polymer.

In a preferred embodiment, wherein the transition metal is selected from the transition metals in Group IB, VIB, VIIB and VIII of the Periodic Table and combinations thereof; preferably, the transition metal is selected from transition metals in Group IB and VIIB of the Periodic Table and combinations thereof; more preferably, the transition metal is selected from the group consisting of Fe, Co, Ni, Cu, Ag, Au and combinations thereof.

In a preferred embodiment, wherein the clay is selected from the group consisting of montmorillonite, sepiolite, steatite, bentonite clay, bentonite, zeolite, kaolin and combinations thereof; preferably, the clay is selected from the group consisting of montmorillonite, sepiolite, and combinations thereof.

In a preferred embodiment, wherein the transition metal ion and the clay are present in a rate from 0.1 to 5 clay-ion-exchange-capacity, preferably from 0.5 to 3 clay-ion-exchange-capacity, more preferably from 0.8 to 2 clay-ion-exchange-capacity, most preferably from 1 to 1.5 clay-ion-exchange-capacity.

In a preferred embodiment, wherein the polymer is selected from the group consisting of polyurethane, polyester, polyamide and combinations thereof; preferably, the polymer is selected from the group consisting of polyamide, such as nylon 6, nylon 66, nylon 1010, nylon 10, nylon 12, nylon 1212, nylon 610, nylon 612, PPA, PA6T, PA9T and combinations thereof; more preferably, the polymer is selected from the group consisting of PET, PBT, PTT and combinations thereof.

In a preferred embodiment, wherein the transition metal ion-modified clay has an amount of 0.5 to 10 parts by weight, preferably 1 to 8 parts by weight, more preferably 1.5 to 6 parts by weight, most preferably 2 to 5 parts by weight, based on 100 parts by weight of the polymer.

In a preferred embodiment, wherein the transition metal ion-modified clay is used together with other additives, such as antioxidant, antistatic agent, foaming agent, flame retardant, lubricant, impact modifier, plasticizer, colorant, filler, etc.

In a preferred embodiment, wherein the transition metal ion-modified clay is used together with a polyhydric alcohol.

In a preferred embodiment, wherein the polyhydric alcohol is selected from the group consisting of ethylene glycol, propylene glycol, glycerin, butanediol, diglycol, polyethylene glycol, pentaerythritol, dipentaerythritol, tri-pentaerythritol and combinations thereof.

In a preferred embodiment, wherein the polyhydric alcohol has an amount of 1 to 10 parts by weight, preferably 1 to 8 parts by weight, more preferably 2 to 7 parts by weight, most preferably 3-6 parts by weight, based on 100 parts by weight of the polymer.

This invention provides a polymer composition having improved heat stability. The transition metal ion-modified clay can greatly increase the heat stability of the polymer, especially the polyamide, with low cost.

### DETAILED DESCRIPTION

In the invention, unless otherwise specified, percentages (%) or parts refer to weight percentages or weight parts.

In the invention, unless otherwise specified, the involved various components or the optimal combination of components can form new technology solutions.

In the invention, unless otherwise specified, the total content of various components of the composition is 100%.

In the invention, unless otherwise specified, the total parts of components of the composite are 100 weight parts.

This invention relates to the use of transition metal ion-modified clay as a heat-stabilizer in a polymer.

In the invention, the transition metals are conventional. It could be any transition metals such as Cu, Fe, Ni, etc. In a preferred embodiment, wherein the transition metal is selected from the transition metals in Group IB, VIB, VIIB and VIII of the Periodic Table and combinations thereof. In another preferred embodiment, the transition metal is selected from transition metals in Group IB and VIIB of the Periodic Table and combinations thereof. In another preferred embodiment, transition metal is selected from Fe, Co, Ni, Cu, silver, gold and combinations thereof.

In the invention, the clays are conventional clays in the art. Those of ordinary skilled in the art can directly determine which clays can be use in the invention. In a preferred embodiment, wherein the clay is selected from the group consisting of montmorillonite, sepiolite, steatite, bentonite clay, bentonite, zeolite, kaolin and combinations thereof. In another preferred embodiment, the clay is selected from the group consisting of montmorillonite, sepiolite, and combinations thereof.

In the invention, the “modification” refers to the change of the clay original properties such as density, adhesion, compatibility and surface characteristics, etc, by physical or chemical methods. Usually, the physical modification includes a physical mixture or physical adsorption of an additive (e.g. transition metal ion) and a clay. The chemical modification includes the ion exchange reaction between an additive (e.g. a transition metal ion) and a clay to form a modified clay, such as transition metal ion intercalated modified clay.

In the invention, the “modification” can be done by any conventional method in the art. In a preferred embodiment, the modifications include chemical modification or physical modification, and combinations thereof, that is, ion exchange reaction or physical adsorption to form modified clay, such as ion exchange of copper (II) to obtain intercalated modified clay.

In the invention, in the transition metal ion-modified clay, wherein the transition metal ion and the clay are present in a rate of from 0.1 to 5 clay-ion-exchange-capacity, preferably from 0.5 to 3 clay-ion-exchange-capacity, more preferably from 0.8 to 2 clay-ion-exchange-capacity, most preferably from 1 to 1.5 clay-ion-exchange-capacity.

The basic unit structure of montmorillonite is layered plate wherein an aluminum oxygen octahedron sandwiched between two silica tetrahedron by sharing oxygen, thickness of 1 nm, width and length of from several dozens to a few hundreds. Different mineral plates are different in width and length, which gather together by van der Waals force and form interlayer or gallery between plates. In the process of crystal formation of clays (e.g., Montmorillonite), isomorphic phenomenon of crystal replacement could occur, meaning that a small number of high valence ions in a polyhedron are replaced by low valence ions, for example, Al³⁺ was replaced by Mg²⁺ or Fe²⁺, resulting in a permanent negative charge in crystal interlayers. In order to maintain the electrical neutrality throughout the mineral structure, interlayers must rely on the coulomb force to adsorb hydrated metal cations (e.g. Na, Li, K, Ca). These metal cations can ion-exchange with other cation compounds. The ion exchange capacity can be characterized by Cation Exchange Capacity, CEC as meg/100 g, that is 100 g clay contains the equivalent of exchangeable metal cation.

In the invention, the polymers are conventional polymers in the art, such as polyurethane, polyester, and polyamide, etc. In a preferred embodiment, wherein the polymer is selected from the group consisting of polyamide, such as nylon 6, nylon 66, nylon 1010, nylon 10, nylon 12, nylon 1212, nylon 610, nylon 612, PPA, PA6T, PAST and combinations thereof. In another preferred embodiment, the polymer is selected from the group consisting of PET, PBT, PTT and combinations thereof. In this invention, the polymer can be any mixture of two or more polymers

In the invention, the weight rates of the transition metal ion-modified clays to polymers are conventional. Those of ordinary skill in the art can directly determine the rates with known methods. In a preferred embodiment, wherein the transition metal ion-modified clay has an amount of 0.5 to 10 parts by weight, preferably 1 to 8 parts by weight, more preferably 1.5 to 6 parts by weight, most preferably 2 to 5 parts by weight, based on 100 parts by weight of the polymer.

In the invention, the transition metal ion-modified clay can be used together with other common additives, such as antioxidant, antistatic agent, foaming agent, flame retardant, lubricant, impact modifier, plasticizer, colorant, filler, etc.

In the invention, the antioxidants are conventional, and can be any common antioxidant in the art. In a preferred embodiment, wherein antioxidant is selected from the group consisting of alkylphenol, butylated toluene (BHT), phenyl-β-naphthylamine, alkyl para-quinones, alkenyl bisphenol, alkyl phenol sulfide, salicylic acid phenyl ester, mercaptan sulfide, thiopropionate, organic phosphinic compounds, disulfide sulfonates, amide hydrazine, aromatic amide and combinations thereof.

In the invention, the antistatic agents are conventional, and can be any common antistatic agent in the art. In a preferred embodiment, antistatic agent is selected from the group consisting of quaternary ammonium salts, ethoxylated amine, fatty acid esters, sulfonated wax and combinations thereof.

In the invention, the foaming agents are conventional, and can be any common foaming agent in the art. In a preferred embodiment, the foaming agent is selected from the group consisting of nitrogen, carbon dioxide, air, butane, pentane, petroleum ether, difluoro-dichloro methane, azobisformamide, azodiisobutyrate and combinations thereof.

In the invention, the flame retardants are conventional, and can be any common flame retardant in the art. In a preferred embodiment, the flame retardant is selected from the group consisting of compounds containing halogen, phosphorus and nitrogen and/or boron and combinations thereof.

In the invention, the lubricants are conventional, and can be any common lubricant in the art. In a preferred embodiment, the lubricant is selected from the group consisting of fatty acid esters (e.g., fatty monoglyceride) and combinations thereof.

In the invention, the plasticizers are conventional, and can be any common plasticizer in the art. In a preferred embodiment, the plasticizer is selected from the group consisting of terephthalic acid, phthalic acid ester, aliphatic diacid ester, phosphate, chlorinated paraffin and combinations thereof.

In the invention, the fillers are conventional, and can be any common fillers in the art. In a preferred embodiment, the filler is selected from the group consisting of glassfiber, clay, silicates, talc, carbonate and combinations thereof.

In the invention, the amounts of various additives to be used are conventional. Those of ordinary skilled in the art can directly determine the amounts for specific application of various additives. Typically, the amounts of various additives used are 0.1 to 10 parts by weight, preferably 0.5 to 8 parts by weight, more preferably 1 to 5 parts by weight, most preferably 2 to 5 parts by weight, based on 100 parts by weight of the polymer.

The invented composition may also comprise other components, such as polyhydric alcohol. The polyhydric alcohols are conventional. They are common polyhydric alcohols in the art, such as ethylene glycol, propylene glycol, glycerin, butanediol, diglycol, polyethylene glycol, pentaerythritol, dipentaerythritol, tri-pentaerythritol and so on. The amounts of polyhydric alcohols to be used are conventional. Those of ordinary skilled in the art can directly determine the amounts according to the description. In a preferred embodiment, wherein the polyhydric alcohol has an amount of 1 to 10 parts by weight, preferably 1 to 8 parts by weight, more preferably 2 to 7 parts by weight, most preferably 3 to 6 parts by weight, based on 100 parts by weight of the polymer.

In the invention, the transition metal ion-modified clay can combine with the polymer using conventional methods in the art, such as mixing and to extruding.

The invention is further illustrated with the following embodiments. It should be understood that while the following embodiments have been given for the purpose of disclosure, the invention is not to be limited by the particular embodiments contained herein.

### EMBODIMENT 1

### Copper Ion-Modified Clay as Polyamide Heat-Stabilizer

The following is the preparation of copper ion-modified clay by ion exchange. To 300 g sodium base montmorillonite (product of Zhejiang Fenghong Clay Chemicals Co., LTD), copper chloride (CuCl₂) by a quantity equivalent to 1.1 times CEC (CEC, montmorillonite ion exchange capacity, about 0.11 mmol/100 g) was added, the mixture was stirred for 4 h at 50° C. in 1000 ml deionized water solvent. The product was filtered and washed with deionized water until no more chloride ion was detected, dried for 8 hours at 100° C., then ground into size less than 70 μm. Thus copper ion-modified clay Cu²⁺-MMT was obtained. The synthesized copper ion modified clay Cu²⁺-MMT can be used as heat stabilizers in polyamide.

96 Parts of polyamide 66 (product of U.S. Du Pont & Co) and 4 parts of the above obtained copper ion-modified clay Cu²⁺-MMT were mixed and made uniform in high-speed mixer. Copper ion-modified clay heat-stabilized polyamide 66 material was prepared by the process of melt-mixing using twin-screw extruder.

The extrudant of the obtained copper ion-modified clay heat-stabilized polyamide 66 material was then granulated and dried. The copper ion-modified clay is evenly dispersed in the substrate material. The heat aging properties of the composition are collected in Table 1.

### EMBODIMENT 2

### Copper Ion-Modified Clay as Polyamide Heat Stabilizer

98 parts of polyamide 66 (same as in Embodiment 1) and 2 parts of the copper ion-modified clay Cu²⁺-MMT synthesized in Embodiment 1 were mixed and made uniform in high-speed mixer. Copper ion-modified clay heat-stabilized polyamide 66 material was prepared by the process of melt-mixing using twin-screw extruder.

The copper ion-modified clay is evenly dispersed in the substrate material. The heat aging properties of the compositions are collected in Table 1.

### EMBODIMENT 3

### Copper Ion Modified Sepiolite as Polyamide Heat Stabilizer

The following is the preparation of copper ion-modified sepiolite by ion exchange.

To 300 g sepiolite (product of U.S. duPont & Co), copper chloride (CuCl₂) by a quantity equivalent to 2 times CEC (CEC, sepiolite ion exchange capacity, about 0.015 mmol/100 g) was added, the mixture was stirred for 4 h at 50° C. in 1000 ml deionized water solvent. The product was filtered and washed with deionized water until no more chloride ion was detected, dried for 8 hours at 100° C., then ground into size less than 50 μm. Thus copper ion modified sepiolite Cu²⁺-DNM was obtained. The synthesized copper ion-modified sepiolite Cu²⁺-DNM can be used as heat stabilizers in polyamide.

96 Parts of polyamide 66 (product of U.S. duPont & Co) and 4 parts of the above obtained copper ion-modified sepiolite Cu²⁺-DNM were mixed and made uniform in high-speed mixer. Copper ion-modified sepiolite heat-stabilized polyamide 66 material was prepared by the process of melt-mixing using twin-screw extruder. The heat aging properties of the composition are collected in Table 1.

### COMPARATIVE EXAMPLE 1

99.5 Parts of polyamide 66 (same as in Embodiment 1) and 0.5 parts of copper iodide/potassium iodide heat stabilizer (product of Switzerland Ciba Company) were mixed and made uniform in high-speed mixer. The copper iodide heat-stabilized polyamide 66 material was prepared by the process of melt-mixing using twin-screw extruder. The heat aging properties of the to composition are collected in Table 1.

### COMPARATIVE EXAMPLE 2

96 Parts of polyamide 66 (same as in Embodiment 1) and 4 parts of sodium base montmorillonite (same as in Embodiment 1) were mixed and made uniform in high-speed mixer. The sodium base montmorillonite filled Polyamide 66 material was prepared by the process of melt-mixing using twin-screw extruder. The heat aging properties of the composition are collected in Table 1.

### COMPARATIVE EXPERIMENT 3

Polyamide 66 (same as in Embodiment 1) without heat-stabilizer. The heat aging properties of the material are collected in Table 1.

### EMBODIMENT 4

The following is the preparation of organic modified copper ion-modified clay by ion exchange.

To 300 g sodium base montmorillonite (product of Zhejiang Fenghong Clay Chemicals Co., LTD), copper chloride (CuCl₂) by a quantity equivalent to 0.5 times CEC (CEC, montmorillonite ion exchange capacity, about 0.11 mmol/100 g) was added, the mixture was stirred for 4 h at 50° C. in 1000 ml deionized water solvent. Octadecyltrimethylammonium chloride by a quantity equivalent to 0.5 times CEC was then added, the mixture was stirred for 4 h at 70° C. The product was filtered and washed with deionized water until no more chloride ion was detected, dried for 8 hours at 100° C., then ground into size less than 70 μm. Thus organic modified copper ion-modified clay Cu²⁺-OMMT was obtained. The synthesized organic modified copper ion modified clay Cu²⁺-OMMT can be used as heat stabilizers in polyamide.

96 Parts of polyamide 66 (same as in Embodiment 1) and 4 parts of the above obtained organic modified copper ion-modified clay Cu²⁺-OMMT were mixed and made uniform in high-speed mixer. The organic modified copper ion-modified clay heat-stabilized polyamide 66 material was prepared by the process of melt-mixing using twin-screw extruder. The organic modified copper ion-modified clay is evenly dispersed in the substrate material.

### EMBODIMENT 5

The following is the preparation of ferric ion modified clay by ion exchange.

To 300 g sodium base montmorillonite (product of Zhejiang Fenghong Clay Chemicals Co., LTD), ferric chloride (FeCl₃) by a quantity equivalent to 1.5 times CEC (CEC, montmorillonite ion exchange capacity, about 0.11 mmol/100 g) was added, the mixture was stirred for 4 h at 50° C. in 1000 ml deionized water solvent. The product was filtered and washed with deionized water until no more chloride ion was detected, dried for 8 hours at 100° C., then ground into size less than 70 μm. Ferric ion-modified clay Fe³⁺-MMT was obtained. The synthesized ferric ion-modified clay Fe³⁺-MMT can be used as heat stabilizers in polyamide.

96 parts of polyamide 66 (same as in Embodiment 1) and 4 parts of the above obtained ferric ion-modified clay Fe³⁺-MMT were mixed and made uniform in high-speed mixer. Ferric ion-modified clay heat-stabilized polyamide 66 material was prepared by the process of melt-mixing using twin-screw extruder.

### EMBODIMENT 6

The following is the preparation of nickel ion-modified clay by ion exchange.

To 300 g sodium base montmorillonite (product of Zhejiang Fenghong Clay Chemicals Co., LTD), nickel chloride (NiCl₂) by a quantity equivalent to 1.1 times CEC (CEC, montmorillonite ion exchange capacity, about 0.11 mmol/100 g) was added, the mixture was stirred for 4 h at 50° C. in 1000 ml deionized water solvent. The product was filtered and washed with deionized water until no more chloride ion was detected, dried for 8 hours at 100° C., then ground into size less than 70 μm. Nickel ion-modified clay Ni²⁺-MMT was obtained. The synthesized nickel ion-modified clay Ni²⁺-MMT can be used as heat stabilizers in polyamide.

96 Parts of polyamide 66 (same as in Embodiment 1) and 4 parts of the above obtained nickel ion-modified clay Ni²⁺-MMT were mixed and made uniform in high-speed mixer. Nickel ion-modified clay heat-stabilized polyamide 66 material was prepared by the process of melt-mixing using twin-screw extruder.

### EMBODIMENT 7

The following is the preparation of organic modified copper ion-modified sepiolite by ion exchange.

To 300 g sepiolite (U.S. duPont & Co), copper chloride (CuCl₂) by a quantity equivalent to 1.1 times CEC (CEC, sepiolite ion exchange capacity, about 0.015 mmol/100 g) was added, the mixture was stirred for 4 h at 50° C. in 1000 ml deionized water solvent. Octadecyltrimethylammonium chloride by a quantity equivalent to 0.5 times CEC was then added, the mixture was stirred for 4 h at 70° C. The product was filtered and washed with deionized water until no more chloride ion was detected, dried for 8 hours at 100° C., then ground into size less than 70 μm. Thus organic modified copper ions modified sepiolite Cu²⁺-ODNM was obtained.

96 Parts of polyamide 66 (same as in Embodiment 1) and 4 parts of the above obtained organic modified copper ion-modified sepiolite Cu²⁺-ODNM were mixed and made uniform in high-speed mixer. The organic modified copper ion-modified sepiolite heat-stabilized polyamide 66 material was prepared by the process of melt-mixing using twin-screw extruder.

### EMBODIMENT 8

The following is the preparation of ferric ion modified sepiolite by ion exchange.

To 300 g sepiolite (U.S. duPont & Co), ferric chloride (FeCl₃) by a quantity equivalent to 1.1 times CEC (CEC, sepiolite ion exchange capacity, about 0.015 mmol/100 g) was added, the mixture was stirred for 4 h at 50° C. in 1000 ml deionized water solvent. The product was filtered and washed with deionized water until no more chloride ion was detected, dried for 8 hours at 100° C., then ground into size less than 50 μm. Ferric ion-modified sepiolite Fe³⁺-DNM was obtained. The synthesized ferric ion modified sepiolite Fe³⁺-DNM can be used as heat stabilizers in polyamide.

96 Parts of polyamide 66 (same as in Embodiment 1) and 4 parts of the above obtained ferric ion-modified sepiolite Fe³⁺-DNM were mixed and made uniform in high-speed mixer. Ferric ion-modified sepiolite heat-stabilized polyamide 66 material was prepared by the process of melt-mixing using twin-screw extruder.

### EMBODIMENT 9

The following is the preparation of nickel ion-modified sepiolite by ion exchange.

To 300 g sepiolite (U.S. duPont & Co), nickel chloride (NiCl₂) by a quantity equivalent to 1.1 times CEC (CEC, sepiolite ion exchange capacity, about 0.015 mmol/100 g) was added, the mixture was stirred for 4 h at 50° C. in 1000 ml deionized water solvent. The product was filtered and washed with deionized water until no more chloride ion was detected, dried for 8 hours at 100° C., then ground into size less than 50 μm. Nickel ion-modified sepiolite Ni²⁺-DNM was obtained. The synthesized nickel ion-modified sepiolite Ni²⁺-DNM can be used as heat stabilizers in polyamide.

96 Parts of polyamide 66 (same as in Embodiment 1) and 4 parts of the above obtained nickel ion-modified sepiolite Ni²⁺-DNM were mixed and made uniform in high-speed mixer. Nickel ion-modified sepiolite heat-stabilized polyamide 66 material was prepared by the process of melt-mixing using twin-screw extruder.

TABLE 1
Heat Aging Properties of Polyamide 66 Compositions (Fracture
tensile strength before and after heat aging in forced-air
drying oven at 210° C.)

| | Fracture Tensile Strength | | | Fracture Tensile Strength | | |
|---|---|---|---|---|---|---|
| | (Mpa) | | | Retention (%) | | |
| | 0 h | 250 h | 500 h | 0 h | 250 h | 500 h |
| Embodiment 1 | 88.1 | 70 | 67.5 | 100 | 79.5 | 76.6 |
| Embodiment 2 | 88 | 66.8 | 46.5 | 100 | 75.9 | 52.8 |
| Embodiment 3 | 86.1 | 68.4 | 52.3 | 100 | 79.4 | 60.7 |
| Comparative | 89.1 | 65 | 50.6 | 100 | 73 | 56.8 |
| example 1 | | | | | | |
| Comparative | 85.2 | 56.4 | 5.4 | 100 | 66.2 | 6.3 |
| example 2 | | | | | | |
| Comparative | 86.6 | 52.3 | 12.7 | 100 | 60.4 | 14.7 |
| example 3 | | | | | | |

TABLE 2
Components of Polyamide Compositions in Embodiments and in Comparative Examples

| | | | | Comparative | Comparative | Comparative |
|---|---|---|---|---|---|---|
| | Embodiment 1 | Embodiment 2 | Embodiment 3 | example 1 | example 2 | example 3 |
| Components | [%] | [%] | [%] | [%] | [%] | [%] |
| Polyamide 66 | 96.00 | 98.00 | 96.00 | 99.50 | 96.00 | 100.00 |
| Copper Iodide | | | | 0.50 | | |
| Heat Stabilizer | | | | | | |
| sodium base | | | | | 4.00 | |
| montmorillonite | | | | | | |
| copper ion- | 4.00 | 2.00 | | | | |
| modified clay | | | | | | |
| copper ion- | | | 4.00 | | | |
| modified sepiolite | | | | | | |

### EMBODIMENT 10

66 Parts of polyamide 66 (same as in Embodiment 1) and 4 parts of the copper ion modified clay obtained in Embodiment 1 were mixed and made uniform in high-speed mixer. With 30 parts of fiberglass, copper ion-modified clay heat-stabilized polyamide 66 fiberglass reinforced composition was prepared by the process of melt-mixing using twin-screw extruder.

The resulting extrudant of copper ion-modified clay heat-stabilized polyamide 66 was then granulated and dried. The heat aging properties of the composition are collected in Table 3 and Table 4.

### EMBODIMENT 11

65 Parts of polyamide 66 (same as in Embodiment 1), 2 parts of the copper ion-modified clay obtained in Embodiment 1 and 3 parts of dipentaerythritol (product of Shanghai Sinopharm Chemical Reagent Co. Ltd.) were mixed and made uniform in high-speed mixer. With 30 parts of fiberglass, copper ion-modified clay heat-stabilized polyamide 66 fiberglass reinforced composition was prepared by the process of melt-mixing using twin-screw extruder.

The resulting extrudant of copper ion-modified clay heat-stabilized polyamide 66 was then granulated and dried. The heat aging properties of the composition are collected in Table 3 and Table 4.

### EMBODIMENT 12

65 parts of polyamide 66 (same as in Embodiment 1), 2 parts of the copper ion modified clay obtained in Embodiment 1 and 3 parts of tri-pentaerythritol (product of Shanghai Sinopharm Chemical Reagent Co. Ltd.) were mixed and made uniform in high-speed mixer. With 30 parts of fiberglass, copper ion-modified clay heat-stabilized polyamide 66 fiberglass reinforced composition was prepared by the process of melt-mixing using twin-screw extruder.

The resulting extrudant of copper ion-modified clay heat-stabilized polyamide 66 was then granulated and dried. The heat aging properties of the composition are collected in Table 3 and Table 4.

### COMPARATIVE EXAMPLE4

69.5 Parts of polyamide 66 (same as in Embodiment 1), and 0.5 parts of copper iodide/potassium iodide heat stabilizer (product of Switzerland Ciba company) were mixed and made uniform in high-speed mixer. With 30 parts of fiberglass, the copper iodide heat-stabilized polyamide 66 fiberglass reinforced composition was prepared by the process of melt-mixing using twin-screw extruder. The heat aging properties of the composition are collected in Table 3 and Table 4.

### COMPARATIVE EXAMPLE 5

65.5 Parts of polyamide 66 (same as in Embodiment 1), 0.5 parts of copper iodide/potassium iodide heat stabilizer (same as in Comparative Example 4) and 4 parts of sodium base montmorillonite (same as in Embodiment 1) were mixed and made uniform in high-speed mixer. With 30 parts of fiberglass, the sodium base montmorillonite filled polyamide 66 fiberglass reinforced composition was prepared by the process of melt-mixing using twin-screw extruder. The heat aging properties of the composition are collected in Table 3 and Table 4.

### COMPARATIVE EXAMPLE 6

70 Parts of polyamide 66 (same as in Embodiment 1) and 30 parts of fiberglass were processed by melt-mixing using twin-screw extruder to form polyamide 66 fiberglass reinforced composition. The heat aging properties of is the composition are collected in Table 3 and Table 4.

TABLE 3
Heat Aging Properties of Polyamide 66 Compositions (Fracture
tensile strength before and after heat aging in forced-air
drying oven at 210° C.)

| | Fracture Tensile Strength | | | Fracture Tensile Strength | | |
|---|---|---|---|---|---|---|
| | (Mpa) | | | Retention (%) | | |
| | 0 h | 500 h | 1000 h | 0 h | 500 h | 1000 h |
| Embodiment 10 | 167.9 | 139.5 | 108.5 | 100 | 83.1 | 64.6 |
| Embodiment 11 | 174.5 | 175.4 | 117.8 | 100 | 100.5 | 67.5 |
| Embodiment 12 | 168.4 | 169.6 | 162.7 | 100 | 100.8 | 96.6 |
| Comparative | 189.9 | 130 | 71.7 | 100 | 68.4 | 37.7 |
| example 4 | | | | | | |
| Comparative | 170.6 | 91.5 | 34.2 | 100 | 53.6 | 20 |
| example 5 | | | | | | |
| Comparative | 184.6 | 59.9 | 0 | 100 | 32.4 | 0 |
| example 6 | | | | | | |

TABLE 4
Heat Aging Properties of Polyamide 66 Compositions (Fracture
tensile strength before and after heat aging in forced-air
drying oven at 230° C.)

| | Fracture Tensile Strength | | | Fracture Tensile Strength | | |
|---|---|---|---|---|---|---|
| | (Mpa) | | | Retention (%) | | |
| | 0 h | 500 h | 1000 h | 0 h | 500 h | 1000 h |
| Embodiment 10 | 167.9 | 160.1 | 140.8 | 100 | 95.3 | 83.8 |
| Embodiment 11 | 174.5 | 166.1 | 110.9 | 100 | 95.2 | 63.6 |
| Embodiment 12 | 168.4 | 156.3 | 148.3 | 100 | 92.9 | 88.1 |
| Comparative | 189.9 | 34.7 | 0 | 100 | 18.3 | 0 |
| example 4 | | | | | | |
| Comparative | 170.6 | 25 | 0 | 100 | 14.6 | 0 |
| example 5 | | | | | | |
| Comparative | 184.6 | 0 | 0 | 100 | 0 | 0 |
| example 6 | | | | | | |

TABLE 5
Components of Polyamide Compositions in Embodiments and in Comparative Examples

| | | | | Comparative | Comparative | Comparative |
|---|---|---|---|---|---|---|
| | Embodiment 10 | Embodiment 11 | Embodiment 12 | Example 4 | Example 5 | Examples 6 |
| Components | [%] | [%] | [%] | [%] | [%] | [%] |
| Polyamide 66 | 66.00 | 65.00 | 65.00 | 69.50 | 65.50 | 70.00 |
| Glassfiber | 30.00 | 30.00 | 30.00 | 30.00 | 30.00 | 30.00 |
| Copper Iodide | | | | 0.50 | 0.50 | |
| Heat Stabilizer | | | | | | |
| sodium base | | | | | 4.00 | |
| montmorillonite | | | | | | |
| copper ion- | 4.00 | 2.00 | 2.00 | | | |
| modified clay | | | | | | |
| dipentaerythritol | | 3.00 | | | | |
| tri-pentaerythritol | | | 3.00 | | | |

1. A polymer composition having improved heat stability, comprising a transition metal ion-modified clay and a polymer.

2. The composition of claim 1, wherein the transition metal is selected from the transition metals in Group IB, VIB, VIIB and VIII of the Periodic Table and combinations thereof; preferably, the transition metal is selected from the transition metals in Group IB and VIII of the Periodic Table and combinations thereof; more preferably, the transition metal is selected from the group consisting of Fe, Co, Ni, Cu, Ag, Au and combinations thereof.

3. The composition of claim 1, wherein the clay is selected from the group consisting of montmorillonite, sepiolite, steatite, bentonite clay, bentonite, zeolite, kaolin and combinations thereof; preferably, the clay is selected from the group consisting of montmorillonite, sepiolite, and combinations thereof.

4. The composition of claim 1, wherein the transition metal ion and the clay are present in a rate of from 0.1 to 5 clay-ion-exchange-capacity, preferably from 0.5 to 3 clay-ion-exchange-capacity, more preferably from 0.8 to 2 clay-ion-exchange-capacity, most preferably from 1 to 1.5 clay-ion-exchange-capacity.

5. The composition of claim 1, wherein the polymer is selected from the group consisting of polyurethane, polyester, polyamide and combinations thereof; preferably, the polymer is selected from the group consisting of polyamide, such as nylon 6, nylon 66, nylon 1010, nylon 10, nylon 12, nylon 1212, nylon 610, nylon 612, PPA, PAST, PA9T and combinations thereof; more preferably, the polymer is selected from the group consisting of PET, PBT, PTT and combinations thereof.

6. The composition of claim 1, wherein the transition metal ion-modified clay has an amount of 0.5 to 10 parts by weight, preferably 1 to 8 parts by weight, more preferably 1.5 to 6 parts by weight, most preferably 2 to 5 parts by weight, based on 100 parts by weight of the polymer.

7. The composition of claim 1, wherein the transition metal ion-modified clay is used together with other additives, such as antioxidant, antistatic agent, foaming agent, flame retardant, lubricant, impact modifier, plasticizer, colorant, filler, etc.

8. The composition of claim 1, wherein the transition metal ion-modified clay is used together with a polyhydric alcohol.

9. The composition of claim 8, wherein the polyhydric alcohol is selected from the group consisting of ethylene glycol, propylene glycol, glycerin, butanediol, diglycol, polyethylene glycol, pentaerythritol, dipentaerythritol, tri-pentaerythritol and combinations thereof.

10. The composition of claim 8, wherein the polyhydric alcohol has an amount of 1 to 10 parts by weight, preferably 1 to 8 parts by weight, more preferably 2 to 7 parts by weight, most preferably 4 to 6 parts by weight, based on 100 parts by weight of the polymer.
